(19) United States
(12) Patent Application Publication
(10) Pub. No.: US 2006/0072886 A1
(43) Pub. Date: Apr. 6, 2006

(54) Loose tube optical cable

(76) Inventors: Tae-Gyoung Kim, Busan (KR); Min Son, Gyeongsangbuk-do (KR)

Correspondence Address: JONES DAY, 222 EAST 41ST ST, NEW YORK, NY, 10017, US

(21) Appl. No.: 10/536,487

(22) PCT Filed: Apr. 8, 2003
(86) PCT No.: PCT/KR03/00696

§ 371 Date: May 24, 2005

(30) Foreign Application Priority Data
Feb. 25, 2003 (KR) 10-2003-0011768

(51) Int. Cl. G02B 6/04

(52) U.S. Cl. 385/115

(57) ABSTRACT

Disclosed is a loose tube optical cable, which includes at most four cable aggregation units longitudinally twisted in contact with a central tensile member and having a loose tube optical fiber unit or inclusion, a cable coating for longitudinally surrounding a cable core aggregation having the central tensile member and the cable aggregation units, and one selected from the group consisting of a fibered tension-reinforcing member for surrounding the cable core aggregation, a wired tension-reinforcing member and a ring-shaped tension-reinforcing member formed in the cable coating. This loose tube optical cable has a compact structure by excluding unnecessary inclusion, thereby decreasing the outer diameter and the weight thereof. In addition, since the central tensile member and the tension-reinforcing member are not twisted with the cable aggregation units, tensile stress may be minimized in the optical cable.

### TECHNICAL FIELD

The present invention relates to a loose tube optical cable, and more particularly to a loose tube optical cable having a more compact structure for reducing an outer diameter and a weight of the optical cable together with satisfying a tensile force requirement of the optical cable.

### BACKGROUND ART

The loose tube optical cable is generally configured so that a plurality of optical fiber units in which the required number of optical fibers are mounted in a plastic tube together with jelly compound (hereinafter, referred to as ‘loose tube optical fiber unit’) are aggregated around a tensile strength member positioned at the center of the cable. At this time, a plurality of the loose tube optical fiber units are aggregated around the tensile strength member in a helical twist or SZ twist in order to minimize the stress caused to the optical fiber by the bending of the optical cable when the optical cable is installed or taken up around a drum.

The conventional loose tube optical cable generally has 1+5 structure or 1+6 structure in which five or six loose tube optical fiber units are helically twisted or SZ-twisted around one central strength member. In this case, if the number of the optical fiber units required in the loose tube optical cable having 1+5 structure or 1+6 structure is less than 5 or 6, a surplus optical fiber unit is replaced with an inclusion in order to keep a section of the optical cable in its original shape. For example, as shown in FIG. 1, if two optical fiber units 30 are required in the loose tube optical cable 10 having 1+6 structure in which six optical fiber units 30 may be aggregated around one central tensile member 20, four unnecessary optical fiber units are substituted with inclusions 40. In other words, in the case of the loose tube optical cable 10 having 1+6 structure, if the required number of the optical fiber units 30 is less than 6, the units and the inclusions are aggregated around the central tensile member 20 in a ratio of 5:1, 4:2, 3:3, 2:4 or 1:5.

However, in spite of the advantage that the inserted inclusions 40 may keep the original shape of the optical cable 10, the inclusions 40 are substantially not inevitable. In addition, though the required number of the optical fiber units 30 is decreased, the outer diameter and the weight of the optical cable 10 are not substantially lessened due to the inclusions 40.

On the other hand, there is disclosed “Optical Fiber Cable” in PCT international publication WO 02/079846 in which the outer diameter and the weight of the optical cable are reduced by means of excluding unnecessary inclusions while having the same number of optical fiber units (three or four) as the loose tube optical cable having 1+5 structure or 1+6 structure. This technique is characterized in that three or four optical fiber units having a tube made of stainless steel are twisted together with a plurality of tensile wires made of aluminum in a longitudinal direction, thereby reducing the outer diameter and the weight of the optical cable as well as satisfying the tensile force requirement of the optical cable.

However, such a technical configuration may be not applicable if the tube of the optical fiber unit is made of plastic. If the loose tube and the metallic tensile wires are twisted together in a longitudinally direction when the tube is made of plastic, the loose tube is pressed between the tensile wires due to the relative difference of strength and elasticity. This may deteriorate the characteristics of the optical fibers mounted in the loose tube and make it harder to arrange a regular three-dimensional twist in a longitudinal direction. In addition, in such a configuration, it is not easy to control the tension of the optical cable during the installation procedure, thereby deteriorating its workability.

The limitation of the technique disclosed in the above-mentioned International Publication WO 02/079846 is not overcome though the material of the tensile member is changed into Fiber glass Reinforced Plastic (FRP), usually used for the tensile member of the optical cable. Due to the strong elastic force, the FRP shows a strong tendency to restore its original shape rather than the metal when its shape is changed. Thus, when using the FRP, it is hard to keep a twisted state of the aggregation composed of the tensile member and the loose tube optical fiber units, and the aggregation is not normally twisted if a twisting pitch is not long. Of course, it may be possible to forcibly keep the twisted state of the aggregation by use of a binder. However in this case, a tensile stress is caused to the aggregation, which may deteriorate the signal characteristics during the optical signal transmission or damage the loose tube itself.

On the other hand, if the twisting pitch is increased when twisting the tensile member and the optical fiber units having the tube made of plastic, the tensile window is decreased, thereby causing a problem in the temperature characteristics of the optical cable. Thus, it also should be considered that there are problems in the cable design in which factors of the optical fiber unit such as EFL (Excess Fiber Length) and the loose tube diameter should be strictly selected.

### DISCLOSURE OF INVENTION

The present invention is designed to solve the problems of the prior art, and therefore an object of the present invention is to provide a loose tube optical cable having an improved structure which may have the same number of loose tube optical fiber units as the conventional 1+5 or 1+6 structure together with reduced optical cable diameter and weight, minimize an effect influenced on the loose tube optical fiber unit due to the optical cable tensile member, and satisfy a tensile force condition of the optical cable.

In one aspect of the present invention for accomplishing the above object, there is provided a loose tube optical cable, which includes a central tensile member extended in a longitudinal direction at the center of the optical cable; a plurality of cable aggregation units twisted and extended in a longitudinal direction on an outer circumference of the central tensile member and having at least one loose tube optical fiber unit; a fibered tension-reinforcing member for surrounding a cable core aggregation including the central tensile member and the cable aggregation units; and a cable coating for longitudinally surrounding the cable core aggregation surrounded by the fibered tension-reinforcing member, wherein the number of the cable aggregation units is 4 or less, and each cable aggregation unit is faced and substantially contacted with other two adjacent cable aggregation units.

This loose tube optical cable may further include wired tension-reinforcing members formed in the cable coating in opposite positions substantially as much as 180°, and extended in a longitudinal direction; a ring-shaped tension-reinforcing member formed in the cable coating and extended substantially coaxially with the central tensile member; or their combination.

According to another aspect of the present invention for accomplishing the above object, a loose tube optical cable includes a central tensile member extended in a longitudinal direction at the center of the optical cable; a plurality of cable aggregation units twisted and extended in a longitudinal direction on an outer circumference of the central tensile member and having at least one loose tube optical fiber unit; a cable coating for surrounding a cable core aggregation including the central tensile member and a plurality of the cable aggregation units; and wired tension-reinforcing members formed in the cable coating in opposite positions substantially as much as 180° and extended in a longitudinal direction, wherein the number of the cable aggregation units is 4 or less, and each cable aggregation unit is faced and substantially contacted with other two adjacent cable aggregation units.

This loose tube optical cable may further include a ring-shaped tension-reinforcing member formed in the cable coating and extended substantially coaxially with the central tensile member.

According to still another aspect of the present invention for accomplishing the above object, a loose tube optical cable includes a central tensile member extended in a longitudinal direction at the center of the optical cable; a plurality of cable aggregation units twisted and extended in a longitudinal direction on an outer circumference of the central tensile member and having at least one loose tube optical fiber unit; a cable coating for surrounding a cable core aggregation including the central tensile member and a plurality of the cable aggregation units; and a ring-shaped tension-reinforcing member formed in the cable coating and extended substantially coaxially with the central tensile member, wherein the number of the cable aggregation units is 4 or less, and each cable aggregation unit is faced and substantially contacted with other two adjacent cable aggregation units.

In the present invention, the term ‘cable aggregation unit’ is defined to designate a component, which is longitudinally twisted in contacted with the central tensile member in order to compose the cable core aggregation. This cable aggregation unit may be the loose tube optical fiber unit or the inclusion according to circumstances. In the present invention, the loose tube optical fiber unit has a tube preferably made of plastic.

In the present invention, the cable core aggregation may have 1+3 structure, in which a plurality of the cable aggregation units may be composed of three loose tube optical fiber units, two loose tube optical fiber units and one inclusion, or one loose tube optical fiber unit and two inclusions.

In another case, the cable core aggregation may have 1+4 structure, in which a plurality of the cable aggregation units may be composed of four loose tube optical fiber units, three loose tube optical fiber units and one inclusion, two loose tube optical fiber units and two inclusions, or one loose tube optical fiber unit and three inclusions.

In the present invention, the fibered tension-reinforcing member and the ring-shaped tension-reinforcing member are preferably made of glass yarn or Aramid yarn, or their combination.

In addition, the wired tension-reinforcing member is preferably made of FRP (Fiber glass Reinforced Plastics), steel wire or plastic-coated steel wire, or their combination.

### BRIEF DESCRIPTION OF THE DRAWINGS

Other objects and aspects of the present invention will become apparent from the following description of embodiments with reference to the accompanying drawing in which:

FIG. 1 is a sectional view showing a conventional loose tube optical cable having 1+6 structure;

FIGS. 2a and 2b are sectional views showing a loose tube optical cable according to a first embodiment of the present invention;

FIGS. 3a and 3b are sectional views showing a loose tube optical cable according to a second embodiment of the present invention;

FIGS. 4a and 4b are sectional views showing a loose tube optical cable according to a third embodiment of the present invention; and

FIGS. 5a to 5c and 6 are sectional views showing an optical cable having at least two tension-reinforcing members according to the present invention.

### BEST MODES FOR CARRYING OUT THE INVENTION

Hereinafter, the present invention will be described in more detail referring to the drawings. First of all, terms and words used in the specification and the claims should be interpreted not in a limited normal or dictionary meaning, but to include meanings and concepts conforming with technical aspects of the present invention, based on the face that inventors may appropriately define a concept of a term to describe his/her own invention in a best way. Therefore, the configurations described in the specification and drawn in the figures are just most preferred embodiments of the present invention, not to show all of the technical aspects of the present invention. So, it should be understood that there might be various equalities and modifications to be replaced with them.

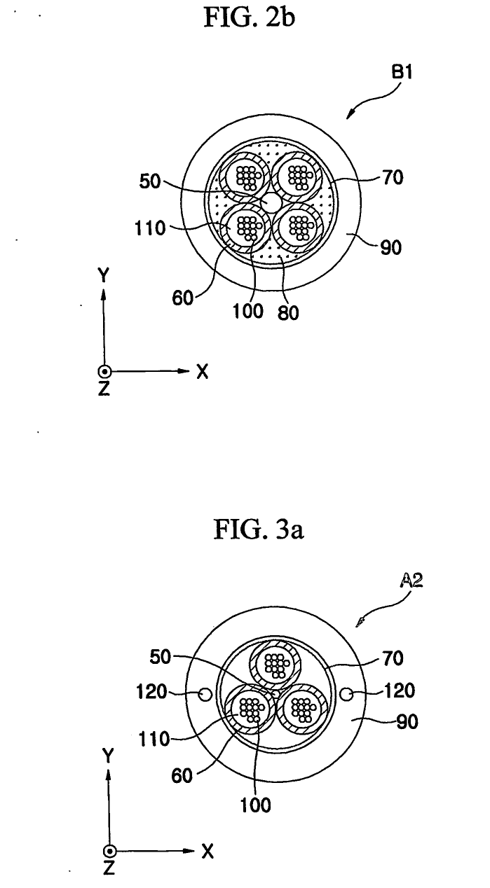

FIGS. 2a and 2b are sectional views respectively showing loose tube optical cables having 1+3 structure and 1+4 structure according to a first embodiment of the present invention.

Referring to FIGS. 2a and 2b, the loose tube optical cable A1 and B1 has a central tensile member 50 longitudinally extended at the center of the optical cable A1 and B1, a plurality of cable aggregation units composed of three or four optical fiber units 60 longitudinally twisted on the outer circumference of the central tensile member 50 in 1+3 structure or 1+4 structure, a fibered tension-reinforcing member 80 for surrounding a cable core aggregation 70 including the central tensile member 50 and the optical fiber units 60, and a cable coating 90 for surrounding the cable core aggregation 70 surrounded by the fibered tension-reinforcing member 80 in a longitudinal direction. Here, the term ‘cable aggregation unit’ is commonly defined as a cylindrical aggregation unit longitudinally twisted and extended on the outer circumference of the central tensile member 50, and it designates the optical fiber unit 60 in the first embodiment of the present invention.

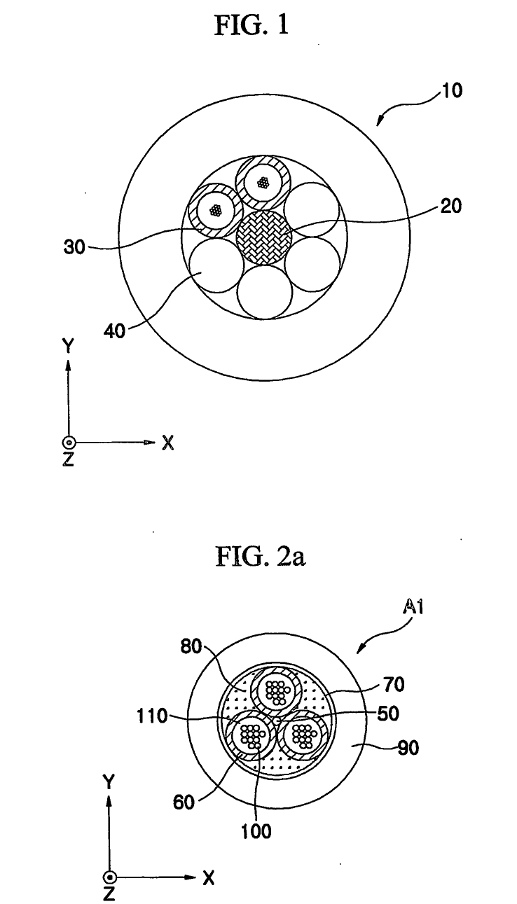

The optical fiber unit 60 is configured so that a plurality of optical fibers 100 having an EFL (Excess Fiber Length) are mounted in a moisture absorbing filler 110, for example jelly compound, included in a loose tube made of plastic such as PBT (Polyethyleneterephthalate), PE (Polyethylene) and PVC (Polyvinylchloride). This optical fiber unit 60 is aggregated in a longitudinal direction with being helically twisted or SZ-twisted on the outer circumference of the central tensile member 50. In this case, though the optical cable A1 and B1 is bent while the optical cable A1 and B1 is installed or taken up around a drum, it is possible to minimize the stress exerted to the optical fibers 100 mounted in the loose tube. A plurality of the optical fiber units 60 are in contact with the outer circumference of the central tensile member 50 and aggregated in a longitudinal direction, and each optical fiber unit 60 is faced and contacted with other two adjacent optical fiber units 60 substantially at an angle of 60° (in the 1+3 structure) or 90° (in the 1+4 structure). By using such configuration, the optical cable A1 and B1 according to the present invention may advantageously have smaller diameter and weight than the conventional optical cable 10 (see FIG. 1) of 1+5 structure or 1+6 structure with the same number of optical fiber units (three or four). The improved configuration of the optical cable A1 and B1 according to the present invention may reduce costs required for manufacturing, transportation or installation of the optical cable A1 and B1.

The central tensile member 50 is positioned in a limited space due to three (1+3 structure) or four (1+4 structure) optical fiber units 60. In addition, the central tensile member 50 is not longitudinally twisted together with the optical fiber units 60 aggregated around its outer circumference. This central tensile member 50 may be made of FRP (Fiber glass Reinforced Plastic), steel wire or plastic-coated steel wire, or their combination. However, though the central tensile member 50 is made of strongly elastic material or metallic material as described above, the present invention may prevent the central tensile member 50 from causing to press the loose tube positioned adjacent to the central tensile member 50 or damaging the loose tube itself since the central tensile member 50 is not twisted longitudinally together with the optical fiber units 60, differently to the prior art.

On the other hand, under the condition that the outer diameter of the optical fiber unit 60 and the material of the central tensile member 50 are identical to those of the conventional optical cable 10 (see FIG. 1) of 1+5 structure or 1+6 structure, the space where the central tensile member 50 may be positioned in the present invention is smaller than the conventional optical cable 10 (see FIG. 1) of 1+5 structure or 1+6 structure. Therefore, the outer diameter of the central tensile member 50 becomes smaller than that of the conventional optical cable 10 (see FIG. 1), so the central tensile member 50 may endure smaller tensile stress than the conventional optical cable 10 (see FIG. 1) when the optical cable A1 and B1 is taken up around a drum or installed.

This decrease of the tensile strength characteristic of the optical cable A1 and B1 caused by the outer diameter reduction of the central tensile member 50 is compensated by using the fibered tension-reinforcing member 80. The fibered tension-reinforcing member 80 provided for reinforcing the tensile strength characteristic of the optical cable A1 and B1 preferably has a thickness at least capable of compensating the deterioration of the tensile strength characteristic of the optical cable A1 and B1 due to the outer diameter decrease of the central tensile member 50. The fibered tension-reinforcing member 80 is preferably whipped and/or inserted to surround the outer circumference of the cable core aggregation 70. In addition, any fibered material having a tensile strength characteristic is used for the fibered tension-reinforcing member 80, but in the present invention the fibered tension-reinforcing member 80 is preferably made of glass yarn, Aramid yarn or their combination.

Though not shown in detail in the figures, the cable coating 90 may be composed of one layer having an outer sheath layer, or multi layers having an inner sheath layer, a moisture-proof layer made of laminated aluminum and an outer sheath layer. However, the present invention is not limited to those cases, but may be changed or modified variously within the scope of the technical aspect well known in the art. The inner sheath layer or the outer sheath layer is preferably made of a plastic resin such as PBT, PE, PVC, halogen free flame retardant thermoplastic or polyurethane.

The optical cable A1 and B1 according to the first embodiment of the present invention may further include a moisture absorptive taping layer for preventing damage of the optical fiber 100 mounted in the loose tube due to water penetration; a moisture absorptive filler (for example, jelly compound); an metallic insulation layer for preventing temperature characteristic deterioration of the optical cable A1 and B1; a cable core aggregation binder, or their combination, around the outer circumference of the cable core aggregation 70. In addition, if there are required at most two optical fiber units 60 in the optical cable A1 and B1 according to the first embodiment of the present invention, an unnecessary optical fiber unit may be substituted with an inclusion (not shown). Though using the inclusion, the optical cable A1 and B1 of the present invention has smaller diameter and weight, compared with the conventional optical cable 10 (see FIG. 1) of 1+5 structure or 1+6 structure under the condition that the number of aggregated optical fiber units 60 is equal. If the optical fiber unit 60 is replaced with the inclusion, the optical fiber unit 60 and the inclusion composes a plurality of cable aggregation units according to the present invention.

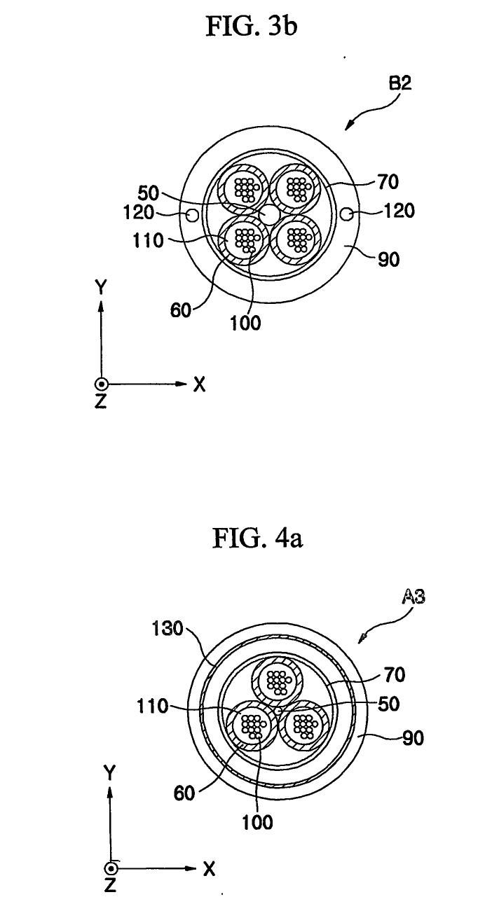

FIGS. 3a and 3b are sectional views showing a loose tube optical cable of 1+3 structure or 1+4 structure according to a second embodiment of the present invention.

Referring to FIGS. 3a and 3b, the loose tube optical cable A2 and B2 according to the second embodiment of the present invention is provided with wired tension-reinforcing members 120 formed in the cable coating 90 in opposite positions substantially as much as 180° and extended in a longitudinal direction, instead of the above-mentioned fibered tension-reinforcing member 80 (see FIGS. 2a and 2b) of the first embodiment. In the second embodiment of the present invention, a plurality of cable aggregation units are the loose tube optical fiber units 60 longitudinally twisted and extended on the outer circumference of the central tensile member 50.

The wired tension-reinforcing members 120 are preferably provided in point symmetry for the central tensile member 50 in order to efficiently disperse the tensile stress applied to the optical cable A2 and B2. The wired tension-reinforcing member 120 may use any material if it has the tensile strength characteristic and is elastic so as to keep its original shape. In this embodiment of the present invention, the wired tension-reinforcing member 120 is preferably made of FRP (Fiber glass Reinforced Plastic), steel wire or plastic-coated steel wire, or their combination.

Since the outer diameter of the central tensile member 50 decreases and gives deteriorated tensile strength to the optical cable A2 and B2, compared with the conventional optical cable 10 (see FIG. 1) of 1+5 structure or 1+6 structure, material and outer diameter of the wired tension-reinforcing member 120 are preferably determined on the consideration of compensation of the deteriorated tensile strength.

The cable coating 90 may have a single-layer structure or a multi-layer structure similar to the first embodiment. In case of the multi-layer structure, the wired tension-reinforcing member 120 is prepared in the inner sheath layer and/or the outer sheath layer. The wired tension-reinforcing member 120 is preferably inserted into the inner sheath layer and/or the outer sheath layer during the sheath extruding process when manufacturing the optical cable A2 and B2.

If there are required at most two optical fiber units 60 in the optical cable A2 and B2 according to the second embodiment of the present invention, an unnecessary optical fiber unit may be substituted with an inclusion (not shown). Though using the inclusion, the optical cable A2 and B2 of the present invention has smaller diameter and weight, compared with the conventional optical cable 10 (see FIG. 1) of 1+5 structure or 1+6 structure under the condition that the number of aggregated optical fiber units 60 is equal. If the optical fiber unit 60 is replaced with the inclusion, the optical fiber unit 60 and the inclusion composes a plurality of cable aggregation units according to the present invention.

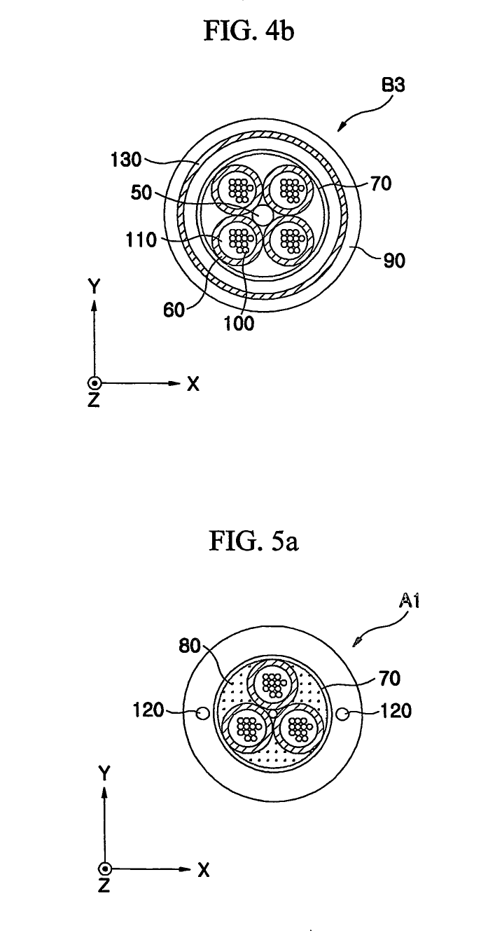

FIGS. 4a and 4b are sectional views showing a loose tube optical cable of 1+3 structure or 1+4 structure according to a third embodiment of the present invention.

Referring to FIGS. 4a and 4b, the loose tube optical cable A3 and B3 according to the third embodiment of the present invention is provided with a fibered ring-shaped tension-reinforcing member 130 formed in the cable coating 90 and extended substantially coaxially with the central tensile member 50, instead of the above-mentioned fibered tension-reinforcing member 80 (see FIGS. 2a and 2b) of the first embodiment. In the third embodiment of the present invention, a plurality of cable aggregation units are the loose tube optical fiber units 60 longitudinally twisted and extended on the outer circumference of the central tensile member 50.

The ring-shaped tension-reinforcing member 130 is preferably provided in point symmetry for the central tensile member 50 in order to efficiently disperse the tensile stress applied to the optical cable A3 and B3. The ring-shaped tension-reinforcing member 130 may be made of any fibered material having the tensile strength characteristic. In this embodiment of the present invention, the ring-shaped tension-reinforcing member 130 is preferably made of glass yarn or Aramid yarn, or their combination.

Since the outer diameter of the central tensile member 50 decreases and gives deteriorated tensile strength to the optical cable A3 and B3, compared with the conventional optical cable 10 (see FIG. 1) of 1+5 structure or 1+6 structure, material and thickness of the ring-shaped tension-reinforcing member 130 are preferably determined on the consideration of compensation of the deteriorated tensile strength.

The cable coating 90 may have a single-layer structure or a multi-layer structure similar to the first embodiment. In case of the multi-layer structure, the ring-shaped tension-reinforcing member 130 may be selectively prepared in the inner sheath layer and/or the outer sheath layer. The ring-shaped tension-reinforcing member 130 is preferably whipped and/or inserted into the inner sheath layer and/or the outer sheath layer during the sheath extruding process when manufacturing the optical cable A3 and B3.

If there are required at most two optical fiber units 60 in the optical cable A3 and B3 according to the third embodiment of the present invention, an unnecessary optical fiber unit may be substituted with an inclusion (not shown). Though using the inclusion, the optical cable A3 and B3 of the present invention has smaller diameter and weight, compared with the conventional optical cable 10 (see FIG. 1) of 1+5 structure or 1+6 structure under the condition that the number of aggregated optical fiber units 60 is equal. If the optical fiber unit 60 is replaced with the inclusion, the optical fiber unit 60 and the inclusion composes a plurality of cable aggregation units according to the present invention.

The optical cable may include at least two tension-reinforcing members by combining the above-mentioned structures of the first to third embodiments. This is described below in detail by using the optical cable of 1+3 structure as an example. However, it is also apparent to those skilled in the art that this may be substantially applied to the optical cable having 1+4 structure according to the present invention in the same way.

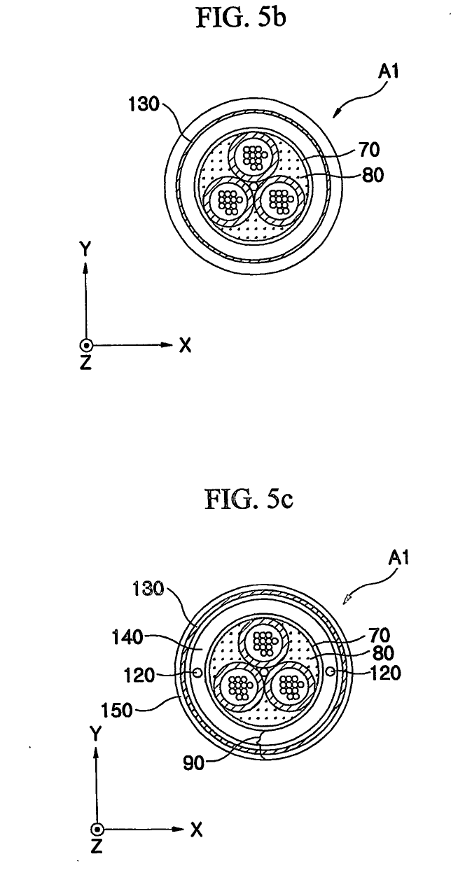

More specifically, the optical cable A1 according to the first embodiment of the present invention may further include the wired tension-reinforcing member 120 and/or the ring-shaped tension-reinforcing member 130 in addition to the fibered tension-reinforcing member 80 as shown in FIGS. 5a, 5b and 5c. At this time, if both of the wired tension-reinforcing member 120 and the ring-shaped tension-reinforcing member 130 are further provided to the optical cable A1 of the first embodiment, it is preferable that the cable coating 90 is realized in the multi-layer structure having the inner sheath layer 140 and the outer sheath layer 150, and the wired tension-reinforcing member 120 and the ring-shaped tension-reinforcing member 130 are prepared in different layers as shown in FIG. 5c.

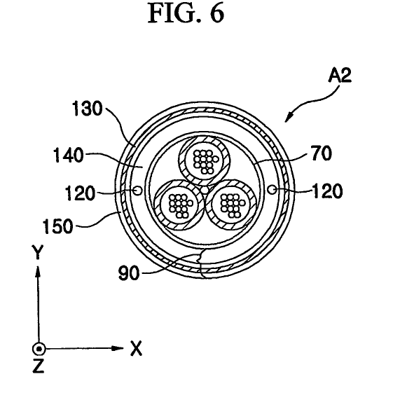

The optical cable A2 according to the second embodiment of the present invention may also further include the ring-shaped tension-reinforcing member 130 provided in the cable coating 90, in addition to the wired tension-reinforcing member 120, as shown in FIG. 6.

If the optical cable of the present invention is provided with at least two kinds of tension-reinforcing members as described above, the tensile strength of the optical cable is more improved, thereby more effectively preventing deterioration of the optical characteristics caused by the tensile stress.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

According to one aspect of the present invention, it is possible to reduce outer diameter and weight of the optical cable since unnecessary inclusions may be excluded though the optical cable has the same number of loose tube optical fiber units as the conventional optical cable of 1+5 structure or 1+6 structure.

According to another aspect of the present invention, it becomes possible to prevent deterioration of the optical characteristics or damage of the loose tube due to the tensile stress caused in the optical cable itself since the central tensile member is not twisted together with the loose tube optical fiber units.

According to still another aspect of the present invention, the tensile strength requirement for the loose tube optical cable may be satisfied easily by providing separate tension-reinforcing members in addition to the central tensile member.

What is claimed is:

1. A loose tube optical cable comprising:
(a) a central tensile member extended in a longitudinal direction at the center of the optical cable;
(b) a plurality of cable aggregation units twisted and extended in a longitudinal direction on an outer circumference of the central tensile member and having at least one loose tube optical fiber unit;
(c) a fibered tension-reinforcing member for surrounding a cable core aggregation including the central tensile member and the cable aggregation units; and
(d) a cable coating for longitudinally surrounding the cable core aggregation surrounded by the fibered tension-reinforcing member,
wherein the number of the cable aggregation units is 4 or less, and each cable aggregation unit is faced and substantially contacted with other two adjacent cable aggregation units.

2. A loose tube optical cable according to claim 1, wherein the loose tube optical fiber unit has a tube made of plastic.

3. A loose tube optical cable according to claim 1,
wherein the cable core aggregation has 1+3 structure, and
wherein a plurality of the cable aggregation units are composed of three loose tube optical fiber units, two loose tube optical fiber units and one inclusion, or one loose tube optical fiber unit and two inclusions.

4. A loose tube optical cable according to claim 1,
wherein the cable core aggregation has 1+4 structure, and
wherein a plurality of the cable aggregation units are composed of four loose tube optical fiber units, three loose tube optical fiber units and one inclusion, two loose tube optical fiber units and two inclusions, or one loose tube optical fiber unit and three inclusions.

5. A loose tube optical cable according to claim 1, further comprising
wired tension-reinforcing members formed in the cable coating in opposite positions substantially as much as 180°, and extended in a longitudinal direction.

6. A loose tube optical cable according to claim 5,
wherein the wired tension-reinforcing member is made of FRP (Fiber glass Reinforced Plastic), steel wire or plastic-coated steel wire, or their combination.

7. A loose tube optical cable according to claim 1 or 5, further comprising a ring-shaped tension-reinforcing member formed in the cable coating and extended substantially coaxially with the central tensile member.

8. A loose tube optical cable according to claim 7,
wherein the ring-shaped tension-reinforcing member is made of glass yarn or Aramid yarn, or their combination.

9. A loose tube optical cable according to claim 1,
wherein a plurality of the cable aggregation units are helically twisted or SZ-twisted in a longitudinal direction around the central tensile member.

10. A loose tube optical cable comprising:
(a) a central tensile member extended in a longitudinal direction at the center of the optical cable;
(b) a plurality of cable aggregation units twisted and extended in a longitudinal direction on an outer circumference of the central tensile member and having at least one loose tube optical fiber unit;
(c) a cable coating for surrounding a cable core aggregation including the central tensile member and a plurality of the cable aggregation units; and
(d) wired tension-reinforcing members formed in the cable coating in opposite positions substantially as much as 180° and extended in a longitudinal direction,
wherein the number of the cable aggregation units is 4 or less, and each cable aggregation unit is faced and substantially contacted with other two adjacent cable aggregation units.

11. A loose tube optical cable according to claim 10, wherein the loose tube optical fiber unit has a tube made of plastic.

12. A loose tube optical cable according to claim 10,
wherein the cable core aggregation has 1+3 structure, and
wherein a plurality of the cable aggregation units are composed of three loose tube optical fiber units, two loose tube optical fiber units and one inclusion, or one loose tube optical fiber unit and two inclusions.

13. A loose tube optical cable according to claim 10,
wherein the cable core aggregation has 1+4 structure, and
wherein a plurality of the cable aggregation units are composed of four loose tube optical fiber units, three loose tube optical fiber units and one inclusion, two loose tube optical fiber units and two inclusions, or one loose tube optical fiber unit and three inclusions.

14. A loose tube optical cable according to claim 10,
wherein the wired tension-reinforcing member is made of FRP (Fiber glass Reinforced Plastic), steel wire or plastic-coated steel wire, or their combination.

15. A loose tube optical cable according to claim 10, further comprising a fibered tension-reinforcing member for surrounding the cable core aggregation in a longitudinal direction.

16. A loose tube optical cable according to claim 15,
wherein the fibered tension-reinforcing member is made of glass yarn or Aramid yarn, or their combination.

17. A loose tube optical cable according to claim 10 or 15, further comprising a ring-shaped tension-reinforcing member formed in the cable coating and extended substantially coaxially with the central tensile member.

18. A loose tube optical cable according to claim 17,
wherein the ring-shaped tension-reinforcing member is made of glass yarn or Aramid yarn, or their combination.

19. A loose tube optical cable according to claim 10,
wherein a plurality of the cable aggregation units are helically twisted or SZ-twisted around the central tensile member.

20. A loose tube optical cable comprising:
(a) a central tensile member extended in a longitudinal direction at the center of the optical cable;
(b) a plurality of cable aggregation units twisted and extended in a longitudinal direction on an outer circumference of the central tensile member and having at least one loose tube optical fiber unit;
(c) a cable coating for surrounding a cable core aggregation including the central tensile member and a plurality of the cable aggregation units; and
(d) a ring-shaped tension-reinforcing member formed in the cable coating and extended substantially coaxially with the central tensile member,
wherein the number of the cable aggregation units is 4 or less, and each cable aggregation unit is faced and substantially contacted with other two adjacent cable aggregation units.

21. A loose tube optical cable according to claim 20, wherein the loose tube optical fiber unit has a tube made of plastic.

22. A loose tube optical cable according to claim 20,
wherein the cable core aggregation has 1+3 structure, and
wherein a plurality of the cable aggregation units are composed of three loose tube optical fiber units, two loose tube optical fiber units and one inclusion, or one loose tube optical fiber unit and two inclusions.

23. A loose tube optical cable according to claim 20,
wherein the cable core aggregation has 1+4 structure, and
wherein a plurality of the cable aggregation units are composed of four loose tube optical fiber units, three loose tube optical fiber units and one inclusion, two loose tube optical fiber units and two inclusions, or one loose tube optical fiber unit and three inclusions.

24. A loose tube optical cable according to claim 20,
wherein the ring-shaped tension-reinforcing member is made of glass yarn or Aramid yarn, or their combination.

25. A loose tube optical cable according to claim 20, further comprising a fibered tension-reinforcing member for surrounding the cable core aggregation in a longitudinal direction.

26. A loose tube optical cable according to claim 25,
wherein the fibered tension-reinforcing member is made of glass yarn or Aramid yarn, or their combination.

27. A loose tube optical cable according to claim 20 or 25, further comprising wired tension-reinforcing members formed in the cable coating in opposite positions substantially as much as 180° and extended in a longitudinal direction.

28. A loose tube optical cable according to claim 27,
wherein the wired tension-reinforcing member is made of FRP (Fiber glass Reinforced Plastic), steel wire or plastic-coated steel wire, or their combination.

29. A loose tube optical cable according to claim 20,
wherein a plurality of the cable aggregation units are helically twisted or SZ-twisted around the central tensile member.
